(19) United States
(12) Patent Application Publication
(10) Pub. No.: US 2023/0101339 A1
(43) Pub. Date: Mar. 30, 2023

(54) AUTOMATIC RESPONSE PREDICTION

(71) Applicant: International Business Machines Corporation, Armonk, NY (US)

(72) Inventor: Ying Li, Mohegan Lake, NY (US)

(21) Appl. No.: 17/486,215

(22) Filed: Sep. 27, 2021

(51) Int. Cl. G06Q 10/10; G06F 16/9535; G06F 16/951; G06F 16/9538

(52) U.S. Cl. CPC G06Q 10/1053; G06F 16/9535; G06F 16/951; G06F 16/9538

(57) ABSTRACT

A system in accordance with the present disclosure may include a memory and a processor in communication with the memory. The processor may be configured to perform operations. The operations may include analyzing a database, identifying an announcement in the database, and compiling a user pool for the announcement. The user pool may include one or more users. The operations may include generating a predicted likelihood of response for each of the one or more users and providing an indication to an operator of the predicted likelihood of response.

### BACKGROUND

The present disclosure relates to talent acquisition and more specifically to predicting the responsiveness of a user.

When an opportunity arises, recruiters may be responsible for screening active candidates as well as identifying quality prospective candidates. Active candidates may include individuals who have submitted applications or otherwise contacted the entity offering the opportunity about the opportunity. Prospective candidates, who may be referred to as passive candidates, may include individuals who have not yet submitted applications despite having the proper qualifications for the role.

### SUMMARY

Embodiments of the present disclosure include a system, method, and computer program product for predicting a propensity to respond.

A system in accordance with the present disclosure may include a memory and a processor in communication with the memory. The processor may be configured to perform operations. The operations may include analyzing a database, identifying an announcement in the database, and compiling a user pool for the announcement. The user pool may include one or more users. The operations may include generating a predicted likelihood of response for each of the one or more users and providing an indication to an operator of the predicted likelihood of response.

The above summary is not intended to describe each illustrated embodiment or every implement of the disclosure.

### BRIEF DESCRIPTION OF THE DRAWINGS

The drawings included in the present application are incorporated into, and form part of, the specification. They illustrate embodiments of the present disclosure and, along with the description, serve to explain the principles of the disclosure. The drawings are only illustrative of certain embodiments and do not limit the disclosure.

FIG. 1 depicts a system for predicting propensity to respond in accordance with some embodiments of the present disclosure.

FIG. 2 illustrates a system for predicting propensity to respond in accordance with some embodiments of the present disclosure.

FIG. 3 depicts a system for predicting propensity to respond in accordance with some embodiments of the present disclosure.

FIG. 4 illustrates a candidate sourcing flow in accordance with some embodiments of the present disclosure.

FIG. 5 depicts a method for predicting propensity to respond in accordance with some embodiments of the present disclosure.

FIG. 6 illustrates a block diagram of an example computing environment in which illustrative embodiments of the present disclosure may be implemented.

FIG. 7 depicts a block diagram of an example natural language processing system configured to analyze a recording to identify a particular subject of a query, in accordance with embodiments of the present disclosure.

FIG. 8 illustrates a cloud computing environment, in accordance with embodiments of the present disclosure.

FIG. 9 depicts abstraction model layers, in accordance with embodiments of the present disclosure.

FIG. 10 illustrates a high-level block diagram of an example computer system that may be used in implementing one or more of the methods, tools, and modules, and any related functions, described herein, in accordance with embodiments of the present disclosure.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention.

### DETAILED DESCRIPTION

Aspects of the present disclosure relate to talent acquisition and more specifically to predicting the responsiveness of a candidate.

Various mechanisms, such as automatic searches and algorithmic identification of potential job candidates, may be used to identify prospective job candidates based on one or more profiles of an individual. For example, a machine learning (ML) instrument may search public social media profiles of an individual and/or a job site for publicly listed résumés or curriculum vitae. Automatic mechanisms may improve the discovery of many high-quality candidates, resulting in an increased number of qualified candidates.

Increasing the number of qualified candidates results in more candidates to sift through for the recruiter, human resources personnel, or other individual interested in filling a role. Some individuals identified as qualified candidates may not be interested in the opportunity. This combination may result in an increased workload. By predicting the propensity of qualified candidates to respond to the opportunity, the recruitment process can be made more efficient and thereby increase productivity of the individuals seeking to fill a role. The propensity to respond may be referred to as the likelihood of a candidate to respond to a recruiter inquiry.

In some embodiments of the disclosure, an ML model may be developed to predict the likelihood of a candidate to respond to an opportunity. The ML model may leverage one or more data sources to construct a propensity to respond score or profile for a specified candidate. The ML model may be trained using information about the candidate including, for example, career movement, career trajectory, current employer, previous employer(s), peer data, and the like. Data sources for training such a ML model may include, for example, public social media profile information, talent market insights, job posting website data, and similar data sources.

A response prediction (which may also be referred to as a propensity to respond) may be the prediction of the likelihood of an individual to respond to an inquiry, such as a cold call, a hot lead, a survey or other data collection, and the like. Some embodiments of the present disclosure may include a data-driven approach to predict the likelihood that a prospective candidate will respond to a recruiter reaching out to the candidate with a job opportunity. In some embodiments of the disclosure, propensity to respond may be the likelihood of a prospective job candidate to respond to a recruiter inquiry.

In some embodiments, a prediction of the propensity to respond may be based on an ML framework. The ML framework may leverage one or more data sources to build the model to predict the propensity to respond. Some examples of data sources the ML framework may leverage may include public social media profiles, company profile data, talent market insights, news stories about companies, and the like. The ML framework may use data from the data source(s) to build a model to predict the likelihood that an individual will respond to an inquiry. For example, the model may assess how likely a prospective candidate is to respond to a recruiter reaching out concerning an open job opportunity.

Various types of features may be extracted from the data sources. Features may be extracted and/or analyzed at different levels of granularity and types of data groups including, for example, one individual, a group of peers, one company, a collection of companies, one industry, a cluster of related industries, one location, a set of similar locations, a skillset, and the like. The features may be submitted to an algorithm to train an ML model, and the trained ML model may predict the likelihood that a candidate will change jobs within a set period of time (e.g., within the next twelve months). The ML model may be used to predict the propensity to respond of a given candidate for a particular role, company, other variable, or combination thereof. The ML model may automatically integrate candidate behavior patterns to better predict the propensity to respond.

In accordance with the present disclosure, multiple data sources that may contain clues as to whether individuals may be open to an opportunity may be identified. The data sources may include, for example, public social media profiles of individuals, company profiles, talent market insight databases, public news stories, and the like. The data sources may supply data to build an ML model based on an ML framework to automatically learn behavior patterns of individuals who may consider changing roles. The ML model may use the data to identify differences between individuals not open to changing roles as well as individuals who may be interested in a change. In some embodiments, the ML model may identify differences between individuals considering certain changes but not others such as, for example, changing job titles, work schedules, companies, industries, careers, or other related changes.

The present disclosure considers a data-driven approach to predict a propensity to respond. The approach may be based on an ML framework to develop an ML model, and the approach may be used on various levels of granularity. For example, the approach may be used to identify an individual, a business unit within a company, a company, or an industry with a high likelihood of responding to an inquiry. In some embodiments, the ML model may identify salient features that indicate a propensity to respond; the salient features may be used, for example, to identify which individuals are likely to respond to an inquiry based on current role, business unit, company, industry, geography, career trajectory, or other variable.

The present disclosure may be applied to any individual given information about the individual is available. For example, if an individual maintains a public professional social media profile, data may be pulled from that profile with respect to the skills, current employer, previous employer, or industry of the individual, and a prediction may be made as to the propensity to respond of the individual.

In some embodiments of the present disclosure, one or more types of data contained in a social network may be used to train the ML model to predict a propensity to respond. Such data may include, for example, an individual's social profile (which may include, e.g., demographics, employment, education, and/or plans for the future), social interaction with other members of the network (e.g., through a social graph), social media website member activities such as interacting with different applications, or services provided by the social network (e.g., interactions with a job recommendation service or job posting service), and the like. The data may be pulled and integrated in an explainable manner such that the ML model may be explained, updated, and revised as preferred and/or as necessary.

Various types of data sources may be used in the present disclosure. For example, public social media profiles, public resumes, submitted resumes, talent market-related insights for an employer or industry that an individual is associated with (e.g., hiring demand, attrition ratio, one-year growth, et cetera), company data (e.g., concerning employer culture, compensation, benefits, career opportunity, horizontal growth opportunities, colleague support, colleague support systems, flexibility, senior management data, reviews of aspects of the company by current employees, and the like), the latest news about the employer (e.g., business expansion, office closures, revenue account, stock price, sales expectation numbers, historical sales data, comparison of historical sales expectations to historical sales data, mergers, acquisitions, and the like), and combinations thereof (e.g., public employee comments on news stories about their employer).

In some embodiments of the present disclosure, the ML framework may integrate substantial data for a variety of data sources such that the resulting ML model is a comprehensive artificial intelligence (AI) model capable of both predicting a propensity to respond and learning to integrate additional data as the data becomes available to enhance its predictions.

A system in accordance with the present disclosure may include a memory and a processor in communication with the memory. The processor may be configured to perform operations. The operations may include analyzing a database, identifying an announcement in the database, and compiling a user pool for the announcement. The user pool may include one or more users. The operations may include generating a predicted likelihood of response for each of the one or more users and providing an indication to an operator of the predicted likelihood of response. In some embodiments, the indication of the predicted likelihood of response may only be provided to the operator if the predicted likelihood of response meets a certain threshold.

In some embodiments of the present disclosure, the operations may further include ranking the one or more users according to the predicted likelihood of response.

In some embodiments of the present disclosure, the operations may further include generating a user profile based on one or more user skills and calculating the predicted likelihood of response based on the user profile. In some embodiments, the operations may further include analyzing the user profile to generate an analysis and determining at least one mechanism to increase the predicted likelihood of response based on the analysis. A mechanism to increase the predicted likelihood of response may be, for example, increasing compensation, changing a benefit option, communicating scheduling flexibility, underscoring daily autonomy, and the like.

In some embodiments of the present disclosure, the operations may further include obtaining announcement information from the database, extracting data from at least one external source, and calculating a calculation with the announcement information and with the data, wherein the calculation is used to generate the predicted likelihood of response.

In some embodiments of the present disclosure, the operations may further include extracting data from a social profile, a talent market repository, a company repository, and a news repository and submitting the data to the database.

In some embodiments of the present disclosure, the operations may further include selecting one or more qualified users from the user pool based on sought qualifications of the announcement and a qualifications profile for each of the one or more users.

In some embodiments of the present disclosure, the operations may further include ascertaining at least one salient feature indicative of the propensity to respond

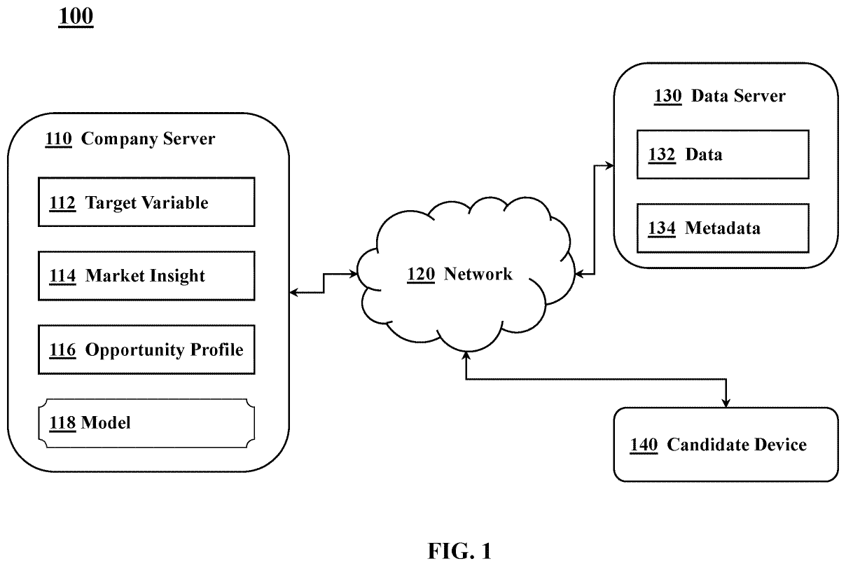

FIG. 1 depicts a system 100 for predicting propensity to respond in accordance with some embodiments of the present disclosure. The system 100 includes a company server 110 in communication with a data server 130 and a candidate device 140 via a network 120.

The company server 110 may contain information pertaining to an opportunity. The information may include a target variable 112, market insight 114, and an opportunity profile 116. The company server 110 may also contain a model 118 for predicting the propensity of a candidate to respond. In some embodiments, the model 118 may be an ML model or otherwise developed using AI. The model 118 may be trained using the information contained on the company server such as, but not limited to, the target variable 112 and the market insight 114. In some embodiments, the company server 110 may contain and/or use additional information to train the model 118.

The company server 110 may communicate with a data server 130 via a network 120. In some embodiments, the company server 110 may interact with more than one data server 130 such as communicating with various data sources each with its own data server 130. The data server 130 may include data 132 and metadata 134. The company server 110 may pull and/or use the data 132 and metadata 134 to train a model 118 to predict a propensity to respond.

The company server 110 may also communicate with a candidate device 140 via the network 120. A candidate device 140 may be, for example, a computer, a phone, a tablet, a mailbox, or other device capable of receiving a communication. For example, the company server 110 may identify a qualified candidate and submit an inquiry to an email of the candidate for review on the candidate device 140. In some embodiments, the company server 110 may submit an inquiry over the network 120 to a printer to send a candidate a hard copy of the inquiry via mail (e.g., if the candidate indicated a preference for paper copies of mail).

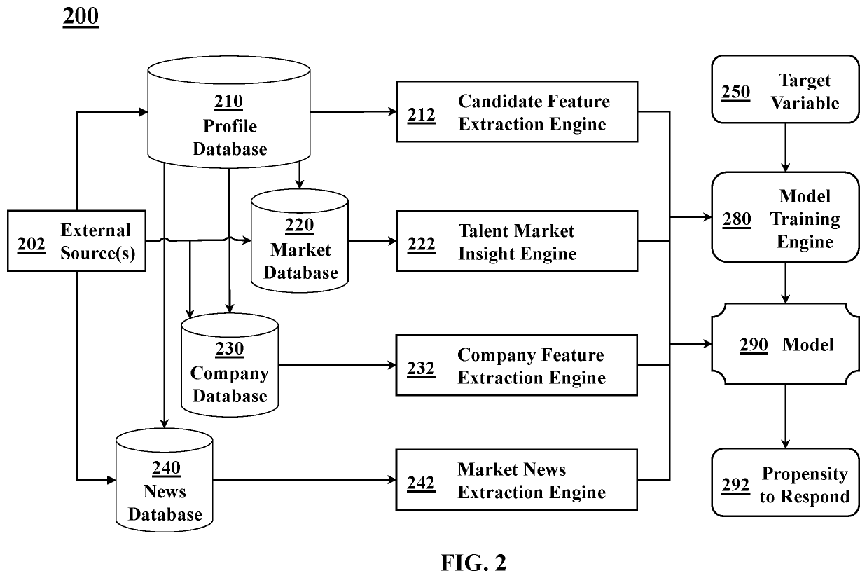

FIG. 2 illustrates a system 200 for predicting propensity to respond in accordance with some embodiments of the present disclosure. The system 200 may include one or more external sources 202, databases, extraction and/or insight engines, and/or target variables to render a model 290 for predicting a propensity to respond 292.

A profile database 210 may include one or more public social media profiles, company profiles, and the like. The profile database 210 may receive the public social media profiles from one or more external sources 202 such as social media websites, career sites, social aggregators, social sourcing tools, job boards, news sites, direct submissions, and the like.

Example features about an individual that may be distilled from a public social media profile may include, for example, a job title, skills and expertise area, industry, current company, tenure with current and previous employers, an average tenure with each employer, location (e.g., country, province, state, county, city), seniority (e.g., length of time with the employer compared to others with the employer in similar roles, or the number years of experience in similar roles), career velocity and/or progression over time, the number of jobs changed, the inferred expertise levels along varying dimensions, education, degree(s) and/or certification(s), the user profile update frequency, and the like.

In some embodiments, public social media data may be aggregated in the profile database 210 concerning a candidate of interest, the peers of the candidate, and/or contacts of the candidate. For example, public data may be aggregated for all of the close contacts of a candidate to identify that several of the contacts changed companies recently; in the scenario in which the contacts coalesced at the company of the candidate, the candidate may be less likely to respond to an opportunity inquiry, whereas a scenario in which the contacts recently dispersed from the company of the candidate may indicate a candidate has a higher propensity to respond 292.

The profile database 210 may include any combination of public social media profiles or an aggregated subset thereof. For example, the profile database 210 may include all public social media profile data available, or the profile database 210 may instead include only public social media profile data for a specific geographic region (e.g., within a 50 mile radius of the location of the opportunity). In some embodiments, the profile database 210 may aggregate the public social media profile data for an industry; for example, all public profiles within a certain industry may be contained in the profile database 210. In some embodiments, the profile database 210 may contain public profiles for a specific job title such as, for example, all public profiles listing “data scientist” as a current career role and/or maintain a profile for all companies employing personnel with “data scientist” as a current role.

The present disclosure considers that one or more factors may filter data stored in the profile database 210. For example, in some embodiments, the profile database 210 may include public profiles of individuals in a specific geographic area, in a specific industry, and with a certain job title. In some embodiments, the profile database 210 may consider global public profiles within a specific industry and with a selection of job titles (e.g., data scientist, machine learning engineer, research scientist, and database administrator). In some embodiments, the profile database 210 may include global public profiles of individuals who have published a paper about a specific topic within the previous year.

The profile database 210 may submit candidate information to a candidate feature extraction engine 212. The candidate feature extraction engine 212 may extract features about a specific candidate; such features may be referred to as candidate features. The candidate features may include, for example, education, degree, job title, career velocity, location, industry, company, and the like. The candidate feature extraction engine 212 may submit the extracted candidate features to the model 290, and the model 290 may use the extracted candidate features in its prediction of a propensity to respond 292 for the candidate.

The profile database 210 and one or more external sources 202 may submit data to other databases such as a market database 220, a company database 230, and/or a news database 240. Data the profile database 210 and/or external sources 202 may submit to the market database 220 may include, for example, information about an industry, a company, a geographic area, and/or skills within the market.

The market database 220 may submit candidate information to a talent market insight engine 222. The talent market insight engine 222 may derive insight about the relevant talent market. Talent market insight may include information about, for example, hiring demand within the relevant market, the one-year growth of the market, the hiring ratio, the attrition ratio in the industry and/or the company in general or in a specific location of the market, the skill levels in the market, and the like, as well as variances for each of these variables. Variances may include, for example, that the attrition ratio holds steady over time except for a change in a certain geographic area for candidates with approximately three years of experience, after which the attrition ratio returns to normal. The talent market insight engine 222 may submit the extracted candidate features to the model 290. The model 290 may use the talent market insights to calculate the propensity to respond 292.

The profile database 210 and one or more external sources 202 may submit data to a company profile database 230. Data the profile database 210 and/or external sources 202 may submit to the company profile database 230 may include, for example, information about the company a candidate is currently employed with.

Features about companies may be gathered from one or more sources to identify the costs and benefits of an individual accepting a new opportunity. Example features about a company may include, for example, internal opportunity for career advancement, compensation, benefits, company culture, company values, client experience, manager reviews, trust in senior leadership, diversity of the workforce, inclusion within the workforce, work-life integration, workplace recognition and appreciation, career development support, bureaucracy, cultural mindset (e.g., growth or fixed), agility, social impact, keywords from the pros and cons and headline description of the company, employee engagement level, and the like.

The company profile database 230 may submit company information to a company feature extraction engine 232. The company feature extraction engine 232 may extract features about one or more relevant companies; such features may be referred to as company features. Company features may include, for example, career opportunity within the company, other growth opportunities within the company, company compensation, company benefits, company culture, company values, and the like. The company feature extraction engine 232 may submit the company features to the model 290. The model 290 may use the extracted company features in its prediction of a propensity to respond 292 for the candidate.

The profile database 210 and one or more external sources 202 may submit data to a news database 240. Data the profile database 210 and/or external sources 202 may submit to the news database 240 may include, for example, relevant news stories such as headlines and/or articles about the company a candidate is currently employed with relating to business expansion, employee dismissals, mergers, acquisitions, and the like. For example, if a first company acquires a second company, the press release may be used in conjunction with the data of both companies to identify whether candidates from either of the effected companies are more or less likely to respond to an opportunity inquiry.

The news database 240 may submit news data to a market news extraction engine 242. The market news extraction engine 242 may extract features pertaining to current events; such features may be referred to as news insights, news features, current event insights, or current event features. News features may include, for example, hiring notices, revenue accounting (e.g., stockholder public releases), publications concerning specific skills and expertise, locations of new and/or closing office buildings, company press release data, and the like. The market news extraction engine 242 may submit the news insights to the model 290. The model 290 may use the news insights in its prediction of a propensity to respond 292.

A target variable 250 may be submitted to the model training engine 280 to use in the phase of training the model. The model training engine 280 may output the model 290. During the phase of training the model 290, the target variable 250 may be, for example, an action or change in habits of a candidate. For example, the target variable submitted may be that a candidate changed roles or companies within the previous year. To predict a propensity to respond 292 for a given candidate, a previously trained model 290 may be used to perform the calculation based on the input from engines 212, 222, 232 and 242.

Candidate features, market insights, company features, and news insights may be submitted to a model 290 to predict a propensity to respond 292 of the candidate. In some embodiments, the model 290 may output additional information such as, for example, the likelihood that a certain change will have on the predicted propensity to respond 292. In some embodiments, the model 290 may indicate that mentioning the compensation package in the initial communication will increase (or decrease) the propensity to respond 292 of a candidate to the inquiry. In some embodiments, the model 290 may indicate that a candidate is more or less likely to respond to an inquiry if it contains a reference to working remotely, flexible scheduling, or a certain aspect of corporate culture.

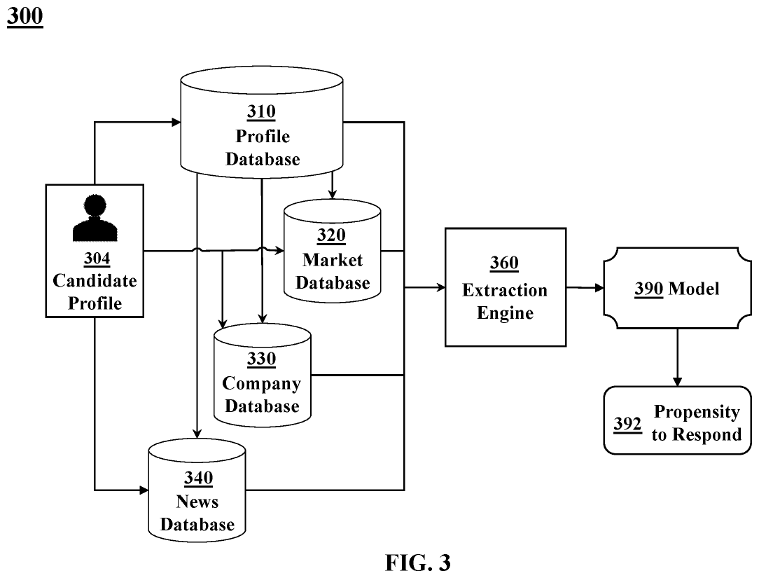

FIG. 3 depicts a system 300 for predicting propensity to respond in accordance with some embodiments of the present disclosure. The system 300 includes a candidate profile 304 submitted to multiple databases, the databases submitting data to an extraction engine 360, and the extraction engine 360 submitting features and/or insights to a model 390 to output a propensity to respond 392. As referenced in FIG. 2, additional sources (e.g., external sources such as news websites) may also be used, or a candidate profile 304 may be retrieved or compiled therefrom.

The candidate profile 304 may be submitted to a profile database 310, a market database 320, a company database 330, and/or a news database 340. In some embodiments, more than one candidate profile 304 may be submitted to the databases, and the databases may separate the profiles into groups of relevance. For example, profiles in the market database 320 may be aggregated by industry type (e.g., data scientist and related roles) whereas profiles in the company database 330 may be aggregated by company (e.g., company A in one group and company B in another group).

The databases may submit data to an extraction engine 360. The extraction engine 360 may extract features and insights related to the candidate, the relevant talent market, the company (or companies) in question, and any germane news. The features and insights may be submitted to the model 290 to calculate the propensity to respond 392.

The extraction engine 360 may also extract insights from metadata and correlations between the data points. For example, the extraction engine 360 may identify that a company press release often precedes an upward shift in the stock price of the company, and that datum may also be submitted to the model 390.

A system in accordance with the present disclosure may include a memory and a processor in communication with the memory. The processor may be configured to perform operations. The operations may include identifying an opportunity and sourcing a candidate pool for the opportunity. The candidate pool may include one or more candidates. The operations may further include associating a propensity to respond with each of the one or more candidates and communicating the propensity to respond with a user.

In some embodiments of the present disclosure, the operations may further include distilling one or more qualified candidates from the candidate pool. Qualified candidates may include, for example, candidates with certain certificates, a specific background, a set number of years of experience, a particular experience, and the like.

In some embodiments of the present disclosure, the operations may further include ranking the one or more qualified candidates according to the propensity to respond. The ranking may be, for example, in numerical order from the most likely to respond to the least likely to respond. In some embodiments, the qualified candidates with a propensity to respond that do not meet a set threshold may not be included in a ranking.

In some embodiments of the present disclosure, the operations may further include calculating the propensity to respond using market insights, opportunity costs, opportunity benefits, and candidate variables. In some embodiments, the operations may additionally include analyzing at least one of the market insights, the opportunity costs, the opportunity benefits, and the candidate variables to determine a mechanism to increase the propensity to respond.

Market insights may include, for example, the attrition rate of a specific role in a certain geographic area, explanations for certain candidates changing roles, compensation and benefits information, and the like. Opportunity costs may include, for example, compensation and benefits, the need to relocate, the price of relocating, the loss of certain contacts, career advancement with a current employer, and the like. Opportunity benefits may include, for example, compensation and benefits, relocation assistance, gaining career contacts, career advancement opportunities with a new employer, and the like. Candidate variables may include, for example, candidate years of experience, types of candidate experience, candidate skills, candidate location, candidate location with respect to office location, candidate office environment preference (e.g., in an office full time, in an office part time, or fully remote work), other delineated candidate preferences, and the like. Mechanisms for increasing a propensity to respond may include, for example, changing the contact medium (e.g., email instead of a physical letter), referencing a particular benefit in an initial contact, changing offered schedule (e.g., offering remote work for Mondays and Fridays rather than for Wednesdays), and the like.

In some embodiments of the present disclosure, the operations may further include training a machine learning model to calculate the propensity to respond. The machine learning model may display the propensity to respond to a user, operator, managing entity, and/or the like. In some embodiments, the machine learning model may also display one or more mechanisms for increasing the propensity to respond for individual candidates and/or for aggregated candidates.

In some embodiments of the present disclosure, the operations may further include extracting data from at least one external source to calculate the propensity to respond. External sources may include, for example, public job posting databases, social media platform databases, online forums, and the like.

In some embodiments of the present disclosure, the operations may further include contacting the at least one or more qualified candidates based on the propensity to respond. A user may, for example, contact the three qualified candidates most likely to respond.

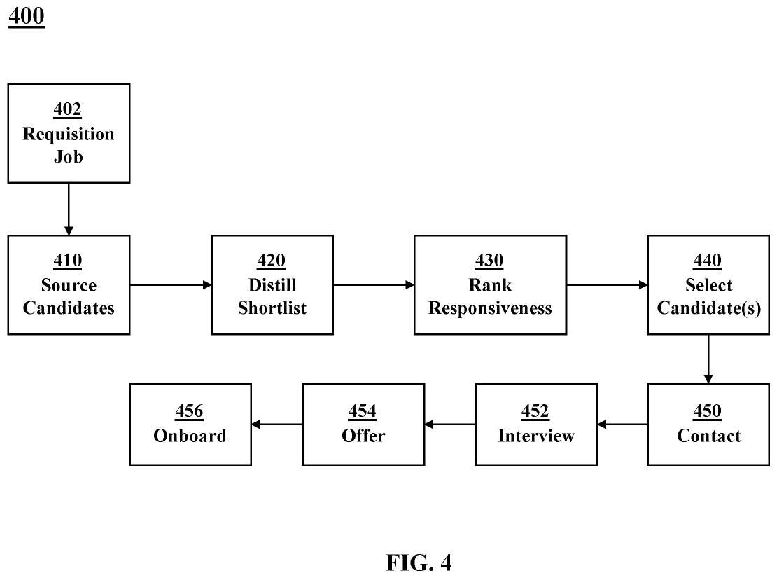

FIG. 4 illustrates a candidate sourcing flow 400 in accordance with some embodiments of the present disclosure. The candidate sourcing flow 400 starts with requisitioning 402 a job, and the requisition is submitted for sourcing 410 of candidates. The flow includes distilling 420 a candidate shortlist and ranking 430 the candidate shortlist according to predicted responsiveness of the candidates on the shortlist. A user (e.g., a human resource professional) may use the ranked shortlist in selecting 440 one or more candidates to contact. The flow continues with the user contacting 450 one or more candidates. Contacting 450 the candidate(s) may lead to interviewing 452, offering 454 a position to, and onboarding 456 the candidate(s).

The candidate sourcing flow 400 includes distilling 420 a candidate pool into a candidate shortlist. The candidate shortlist may include active and passive candidates. An active candidate may be, for example, an individual who submitted a resumé or curriculum vitae in response to a job posting and/or an individual who called a human resource professional to inquire about the job posting. A passive candidate may be, for example, an individual who has not submitted a direct inquiry.

The candidate pool may be distilled into a candidate shortlist. The candidate shortlist may include the candidates qualified for the specific role offered in the job requisition based on, for example, experience, types of experience, years in the industry, and compatibility with company values and corporate culture. The candidate shortlist may then be ranked according to predicted responsiveness, or the propensity of each candidate to respond to an inquiry. The propensity to respond may include, for example, the likelihood that a candidate will answer a phone call from a representative calling to discuss the opportunity, and/or whether a candidate is likely to reply to an email about the opportunity.

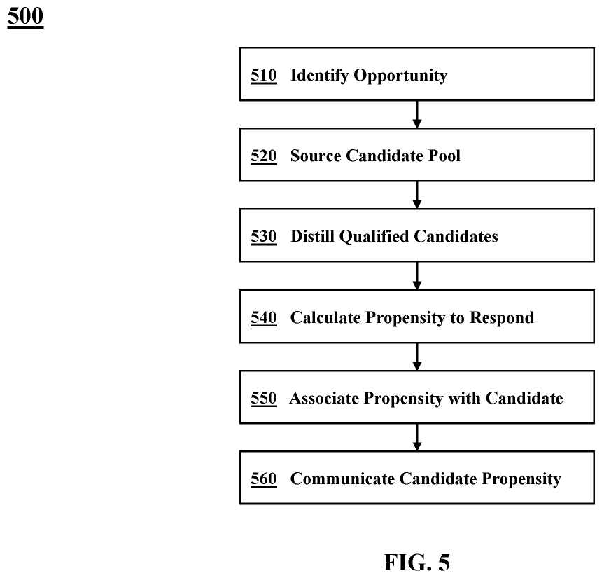

FIG. 5 depicts a method 500 for employing a predicted propensity to respond in accordance with some embodiments of the present disclosure. The method 500 includes identifying 510 an opportunity and sourcing 520 a candidate pool. The method 500 includes distilling 530 the candidate pool into a list of qualified candidates (e.g., screening out candidates lacking the required experience). The method 500 includes calculating 540 the propensity to respond of each of the qualified candidates; a model (such as model 290 shown in FIG. 2) may be used for calculating 540 the propensity to respond. The method 500 includes associating 550 the propensities to respond with their respective candidates and communicating 560 the propensity to respond of each of the candidates with a user.

In accordance with the present disclosure, a method may include identifying 510 an opportunity and sourcing 520 a candidate pool for the opportunity. The candidate pool may include one or more candidates. The method may include associating 550 a propensity to respond with each of the candidates and communicating 560 the propensity to respond to a user.

In some embodiments of the present disclosure, the method may include distilling 530 one or more qualified candidates from the candidate pool. In some embodiments, an ML model may distill the candidate pool into a shortlist of qualified candidates.

In some embodiments of the present disclosure, the method may include training an ML model to calculate the propensity to respond of the candidates.

In some embodiments of the present disclosure, the method may include ranking the plurality of qualified candidates according to the propensity to respond. Qualified candidates may be ranked based on their propensities to respond, and the ranking may be communicated to the user. Such a ranking may use normalized numerical identifiers (e.g., 1-100 responsiveness), order (e.g., candidates in order from most likely to respond to least likely to respond), and/or some combination thereof.

In some embodiments of the present disclosure, the method may include calculating 540 the propensity to respond using market insights, opportunity costs, opportunity benefits, and candidate variables. In some embodiments, the method may further include analyzing at least one of the market insights, the opportunity costs, the opportunity benefits, and the candidate variables to determine a mechanism to increase the propensity to respond. For example, a model (such as model 390 of FIG. 3) may identify that one candidate is more likely to respond if the user sends an email referencing corporate culture whereas another candidate is more likely to respond if the user calls and mentions a certain benefit available to company employees.

In some embodiments of the present disclosure, the method may include extracting data from at least one external source to calculate the propensity to respond. The data may be used, for example, in sourcing 520 the candidate pool, distilling 530 the candidate pool into a list of qualified candidates, and/or calculating 540 a propensity to respond for each of the candidates.

In some embodiments of the present disclosure, the method may include contacting an individual from the plurality of qualified candidates based on the propensity to respond. For example, a system may identify a qualified candidate likely to respond to an inquiry, and the system may submit an automated, pre-designed, tailored, or other communication (e.g., an email or message via a job board) to the candidate.

In some embodiments, the system may group candidates based on likely responsiveness, and the system may submit two lists to a user. The candidates on one list may, for example, have a high propensity to respond whereas the candidates on the other list may have a low propensity to respond. In some embodiments, the system may send automated messages to the candidates on one list (e.g., the candidates with a low propensity to respond) and recommend the user contact the candidates on the other list (e.g., the candidates with a high propensity to respond). Other variables may be used in constructing lists for automated or human contact; for example, a list may be derived of individuals it may be beneficial for the user to contact (e.g., candidates who prefer phone calls) and individuals for whom a message from an automated system will not negatively impact the propensity to respond (e.g., just as likely to respond to automated emails as to human-generated emails).

In some embodiments of the present disclosure, the method may include ascertaining at least one salient feature indicative of the propensity to respond. Salient features may be characteristics that strongly indicate a likelihood to respond, or characteristics that strongly guide a prediction of a candidate to respond. Salient features may indicate likelihood of response in a positive manner such that the presence of a positive salient feature indicates that a candidate is more likely to respond to an inquiry. Salient features may indicate likelihood of response in a negative manner such that the presence of a negative salient feature indicates that a candidate is less likely to respond to an inquiry.

In some embodiments, the presence of a positive salient feature in a candidate profile may indicate with high confidence that a candidate is likely to respond to an inquiry; for example, a positive salient feature may be that candidates who have uploaded a resume within the previous month are very likely to respond to inquiries. In another example, the presence of a negative salient feature may indicate that a candidate is very unlikely to respond to an inquiry; for example, comparing a candidate response patterns and similar inquiries may reveal a salient feature that candidates who mention “research” more than ten times on a resume are unlikely to respond to an inquiry with the term “public relations” in the title. Salient features may vary with candidate titles, industries, experience levels, companies, and the like. Similarly, whether a salient feature (or combination of features) is positive or negative may also vary.

A salient feature may be, for example, that candidates with a certain role are more likely to respond to an inquiry if they have between two and five years of tenure with their current company. Salient features may correlate with the propensity of a candidate to respond to an inquiry or the prediction thereof. Salient features may indicate independently or jointly with other features (whether or not the other features are independently salient) the propensity of a candidate to respond. In some embodiments, certain salient features (e.g., the top ten or top fifty) may be identified to a user and/or recommended for model input data. In some embodiments, salient features may be medium dependent; for example, salient features may identify a certain candidate may be identified as unlikely to respond to a boilerplate email but very likely to respond to a humanized communication such as a phone call.

A method in accordance with the present disclosure may include analyzing a database, identifying an announcement in the database, and compiling a user pool for the announcement. The user pool may include one or more users. The method may include generating a predicted likelihood of response for each of the one or more users and providing an indication to an operator of the predicted likelihood of response.

In some embodiments of the present disclosure, the method may further include ranking the one or more users according to the predicted likelihood of response.

In some embodiments of the present disclosure, the method may further include generating a user profile based on one or more user skills and calculating the predicted likelihood of response based on the user profile. In some embodiments, the method may further include analyzing the user profile to generate an analysis and determining at least one mechanism to increase the predicted likelihood of response based on the analysis.

In some embodiments of the present disclosure, the method may further include training a machine learning model to calculate the predicted likelihood of response.

In some embodiments of the present disclosure, the method may further include obtaining announcement information from the database and extracting data from at least one external source. The method may further include calculating a calculation with the announcement information and with the data, wherein the calculation is used to generate the predicted likelihood of response.

In some embodiments of the present disclosure, the method may further include extracting data from a social profile, a talent market repository, a company repository, and a news repository and submitting the data to the database.

In some embodiments of the present disclosure, the method may further include selecting one or more qualified users from the user pool based on sought qualifications of the announcement and a qualifications profile for each of the one or more users.

In some embodiments of the present disclosure, the method may further include ascertaining a salient feature indicative of the predicted likelihood of response.

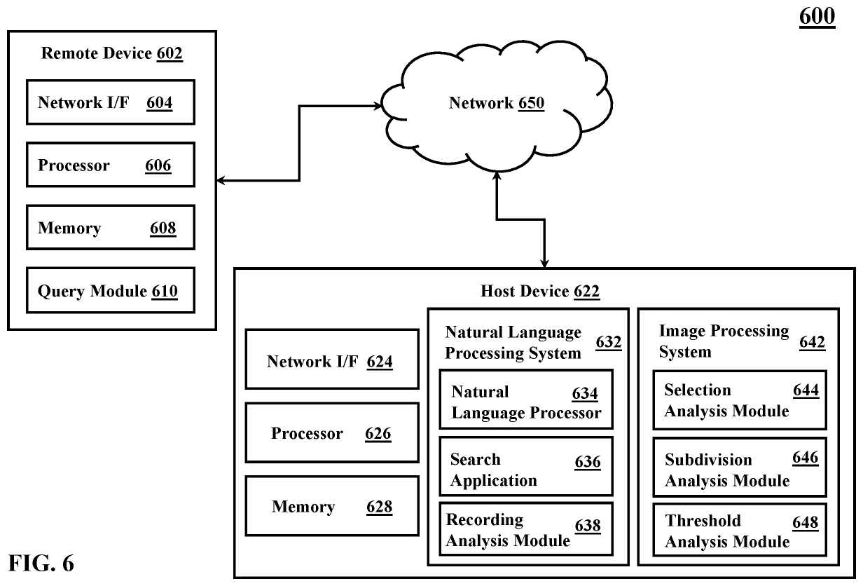

Some embodiments of the present disclosure may utilize a natural language parsing and/or subparsing component. Thus, aspects of the disclosure may relate to natural language processing. Accordingly, an understanding of the embodiments of the present invention may be aided by describing embodiments of natural language processing systems and the environments in which these systems may operate. Turning now to FIG. 6, illustrated is a block diagram of an example computing environment 600 in which illustrative embodiments of the present disclosure may be implemented. In some embodiments, the computing environment 600 may include a remote device 602 and a host device 622.

Consistent with various embodiments of the present disclosure, the host device 622 and the remote device 602 may be computer systems. The remote device 602 and the host device 622 may include one or more processors 606 and 626 and one or more memories 608 and 628, respectively. The remote device 602 and the host device 622 may be configured to communicate with each other through an internal or external network interface 604 and 624. The network interfaces 604 and 624 may be modems or network interface cards. The remote device 602 and/or the host device 622 may be equipped with a display such as a monitor. Additionally, the remote device 602 and/or the host device 622 may include optional input devices (e.g., a keyboard, mouse, scanner, or other input device) and/or any commercially available or custom software (e.g., browser software, communications software, server software, natural language processing software, search engine and/or web crawling software, filter modules for filtering content based upon predefined parameters, etc.). In some embodiments, the remote device 602 and/or the host device 622 may be servers, desktops, laptops, or hand-held devices.

The remote device 602 and the host device 622 may be distant from each other and communicate over a network 650. In some embodiments, the host device 622 may be a central hub from which remote device 602 can establish a communication connection, such as in a client-server networking model. Alternatively, the host device 622 and remote device 602 may be configured in any other suitable networking relationship (e.g., in a peer-to-peer configuration or using any other network topology).

In some embodiments, the network 650 can be implemented using any number of any suitable communications media. For example, the network 650 may be a wide area network (WAN), a local area network (LAN), an internet, or an intranet. In certain embodiments, the remote device 602 and the host device 622 may be local to each other and communicate via any appropriate local communication medium. For example, the remote device 602 and the host device 622 may communicate using a local area network (LAN), one or more hardwire connections, a wireless link or router, or an intranet. In some embodiments, the remote device 602 and the host device 622 may be communicatively coupled using a combination of one or more networks and/or one or more local connections. For example, the remote device 602 may be hardwired to the host device 622 (e.g., connected with an Ethernet cable) or the remote device 602 may communicate with the host device using the network 650 (e.g., over the Internet).

In some embodiments, the network 650 can be implemented within a cloud computing environment or using one or more cloud computing services. Consistent with various embodiments, a cloud computing environment may include a network-based, distributed data processing system that provides one or more cloud computing services. Further, a cloud computing environment may include many computers (e.g., hundreds or thousands of computers or more) disposed within one or more data centers and configured to share resources over the network 650.

In some embodiments, the remote device 602 may enable a user to input (or may input automatically with or without a user) a query (e.g., is any part of a recording artificial, etc.) to the host device 622 in order to identify subdivisions of a recording that include a particular subject. For example, the remote device 602 may include a query module 610 and a user interface (UI). The query module 610 may be in the form of a web browser or any other suitable software module, and the UI may be any type of interface (e.g., command line prompts, menu screens, graphical user interfaces). The UI may allow a user to interact with the remote device 602 to input, using the query module 610, a query to the host device 622, which may receive the query.

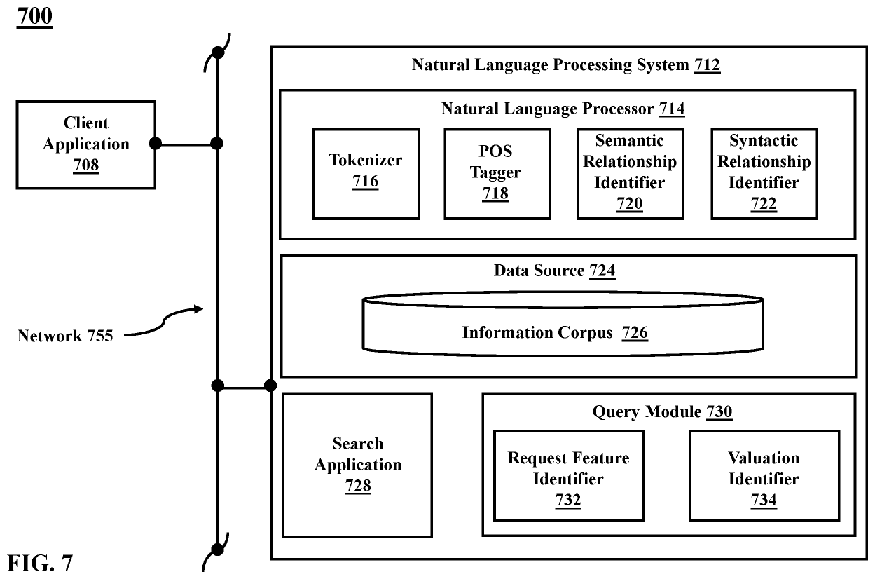

In some embodiments, the host device 622 may include a natural language processing system 632. The natural language processing system 632 may include a natural language processor 634, a search application 636, and a recording module 638. The natural language processor 634 may include numerous subcomponents, such as a tokenizer, a part-of-speech (POS) tagger, a semantic relationship identifier, and a syntactic relationship identifier. An example natural language processor is discussed in more detail in reference to FIG. 7.

The search application 636 may be implemented using a conventional or other search engine and may be distributed across multiple computer systems. The search application 636 may be configured to search one or more databases (e.g., repositories) or other computer systems for content that is related to a query submitted by the remote device 602. For example, the search application 636 may be configured to search dictionaries, papers, and/or archived reports to help identify a particular subject related to a query provided for a class. The recording analysis module 638 may be configured to analyze a recording to identify a particular subject (e.g., of the query). The recording analysis module 638 may include one or more modules or units, and may utilize the search application 636, to perform its functions (e.g., to identify a particular subject in a recording), as discussed in more detail in reference to FIG. 7.

In some embodiments, the host device 622 may include an image processing system 642. The image processing system 642 may be configured to analyze images associated with a recording to create an image analysis. The image processing system 642 may utilize one or more models, modules, or units to perform its functions (e.g., to analyze the images associated with the recording and generate an image analysis). For example, the image processing system 642 may include one or more image processing models that are configured to identify specific images related to a recording. The image processing models may include a section analysis module 644 to analyze single images associated with the recording and to identify the location of one or more features of the single images. As another example, the image processing system 642 may include a subdivision module 646 to group multiple images together identified to have a common feature of the one or more features. In some embodiments, image processing modules may be implemented as software modules. For example, the image processing system 642 may include a section analysis module and a subdivision analysis module. In some embodiments, a single software module may be configured to analyze the image(s) using image processing models.

In some embodiments, the image processing system 642 may include a threshold analysis module 648. The threshold analysis module 648 may be configured to compare the instances of a particular subject identified in a subdivision of sections of the recording against a threshold number of instances. The threshold analysis module 648 may then determine if the subdivision should be displayed to a user.

In some embodiments, the host device may have an optical character recognition (OCR) module. The OCR module may be configured to receive a recording sent from the remote device 602 and perform optical character recognition (or a related process) on the recording to convert it into machine-encoded text so that the natural language processing system 632 may perform NLP on the report. For example, a remote device 602 may transmit a video of an interview to the host device 622. The OCR module may convert the video into machine-encoded text and then the converted video may be sent to the natural language processing system 632 for analysis. In some embodiments, the OCR module may be a subcomponent of the natural language processing system 632. In other embodiments, the OCR module may be a standalone module within the host device 622. In still other embodiments, the OCR module may be located on the remote device 602 and may perform OCR on the recording before the recording is sent to the host device 622.

While FIG. 6 illustrates a computing environment 600 with a single host device 622 and a remote device 602, suitable computing environments for implementing embodiments of this disclosure may include any number of remote devices and host devices. The various models, modules, systems, and components illustrated in FIG. 6 may exist, if at all, across a plurality of host devices and remote devices. For example, some embodiments may include two host devices. The two host devices may be communicatively coupled using any suitable communications connection (e.g., using a WAN, a LAN, a wired connection, an intranet, or the Internet). The first host device may include a natural language processing system configured to receive and analyze a video, and the second host device may include an image processing system configured to receive and analyze .GIFS to generate an image analysis.

It is noted that FIG. 6 is intended to depict the representative major components of an exemplary computing environment 600. In some embodiments, however, individual components may have greater or lesser complexity than as represented in FIG. 6, components other than or in addition to those shown in FIG. 6 may be present, and the number, type, and configuration of such components may vary.

Referring now to FIG. 7, shown is a block diagram of an exemplary system architecture 700 including a natural language processing system 712 configured to analyze data to identify objects of interest (e.g., possible anomalies, natural data, etc.), in accordance with embodiments of the present disclosure. In some embodiments, a remote device (such as remote device 602 of FIG. 6) may submit a text segment and/or a corpus to be analyzed to the natural language processing system 712 which may be housed on a host device (such as host device 622 of FIG. 6). Such a remote device may include a client application 708, which may itself involve one or more entities operable to generate or modify information associated with the recording and/or query that is then dispatched to a natural language processing system 712 via a network 755.

Consistent with various embodiments of the present disclosure, the natural language processing system 712 may respond to text segment and corpus submissions sent by a client application 708. Specifically, the natural language processing system 712 may analyze a received text segment and/or corpus (e.g., video, news article, etc.) to identify an object of interest. In some embodiments, the natural language processing system 712 may include a natural language processor 714, data sources 724, a search application 728, and a query module 730. The natural language processor 714 may be a computer module that analyzes the recording and the query. The natural language processor 714 may perform various methods and techniques for analyzing recordings and/or queries (e.g., syntactic analysis, semantic analysis, etc.). The natural language processor 714 may be configured to recognize and analyze any number of natural languages. In some embodiments, the natural language processor 714 may group one or more sections of a text into one or more subdivisions. Further, the natural language processor 714 may include various modules to perform analyses of text or other forms of data (e.g., recordings, etc.). These modules may include, but are not limited to, a tokenizer 716, a part-of-speech (POS) tagger 718 (e.g., which may tag each of the one or more sections of text in which the particular object of interest is identified), a semantic relationship identifier 720, and a syntactic relationship identifier 722.

In some embodiments, the tokenizer 716 may be a computer module that performs lexical analysis. The tokenizer 716 may convert a sequence of characters (e.g., images, sounds, etc.) into a sequence of tokens. A token may be a string of characters included in a recording and categorized as a meaningful symbol. Further, in some embodiments, the tokenizer 716 may identify word boundaries in a body of text and break any text within the body of text into their component text elements, such as words, multiword tokens, numbers, and punctuation marks. In some embodiments, the tokenizer 716 may receive a string of characters, identify the lexemes in the string, and categorize them into tokens.

Consistent with various embodiments, the POS tagger 718 may be a computer module that marks up a word in a recording to correspond to a particular part of speech. The POS tagger 718 may read a passage or other text in natural language and assign a part of speech to each word or other token. The POS tagger 718 may determine the part of speech to which a word (or other spoken element) corresponds based on the definition of the word and the context of the word. The context of a word may be based on its relationship with adjacent and related words in a phrase, sentence, or paragraph. In some embodiments, the context of a word may be dependent on one or more previously analyzed body of texts and/or corpora (e.g., the content of one text segment may shed light on the meaning of one or more objects of interest in another text segment). Examples of parts of speech that may be assigned to words include, but are not limited to, nouns, verbs, adjectives, adverbs, and the like. Examples of other part of speech categories that POS tagger 718 may assign include, but are not limited to, comparative or superlative adverbs, wh-adverbs, conjunctions, determiners, negative particles, possessive markers, prepositions, wh-pronouns, and the like. In some embodiments, the POS tagger 718 may tag or otherwise annotate tokens of a recording with part of speech categories. In some embodiments, the POS tagger 718 may tag tokens or words of a recording to be parsed by the natural language processing system 712.

In some embodiments, the semantic relationship identifier 720 may be a computer module that may be configured to identify semantic relationships of recognized subjects (e.g., words, phrases, images, etc.) in a body of text/corpus. In some embodiments, the semantic relationship identifier 720 may determine functional dependencies between entities and other semantic relationships.

Consistent with various embodiments, the syntactic relationship identifier 722 may be a computer module that may be configured to identify syntactic relationships in a body of text/corpus composed of tokens. The syntactic relationship identifier 722 may determine the grammatical structure of sentences such as, for example, which groups of words are associated as phrases and which word is the subject or object of a verb. The syntactic relationship identifier 722 may conform to formal grammar.

In some embodiments, the natural language processor 714 may be a computer module that may group sections of a recording into subdivisions and generate corresponding data structures for one or more subdivisions of the recording. For example, in response to receiving a text segment at the natural language processing system 712, the natural language processor 714 may output subdivisions of the text segment as data structures. In some embodiments, a subdivision may be represented in the form of a graph structure. To generate the subdivision, the natural language processor 714 may trigger computer modules 716-722.

In some embodiments, the output of natural language processor 714 may be used by search application 728 to perform a search of a set of (i.e., one or more) corpora to retrieve one or more subdivisions including a particular subject associated with a query (e.g., in regard to an object of interest) and send the output to an image processing system and to a comparator. As used herein, a corpus may refer to one or more data sources, such as a data source 724 of FIG. 7. In some embodiments, data sources 724 may include video libraries, data warehouses, information corpora, data models, and/or document repositories. In some embodiments, the data sources 724 may include an information corpus 726. The information corpus 726 may enable data storage and retrieval. In some embodiments, the information corpus 726 may be a subject repository that houses a standardized, consistent, clean, and integrated list of images and text. For example, an information corpus 726 may include teaching presentations that include step by step images and comments on how to perform a function. Data may be sourced from various operational systems. Data stored in an information corpus 726 may be structured in a way to specifically address reporting and analytic requirements. In some embodiments, an information corpus 726 may be a relational database.

In some embodiments, a query module 730 may be a computer module that identifies objects of interest within sections of a text, or other forms of data. In some embodiments, a query module 730 may include a request feature identifier 732 and a valuation identifier 734. When a query is received by the natural language processing system 712, the query module 730 may be configured to analyze text using natural language processing to identify an object of interest. The query module 730 may first identity one or more objects of interest in the text using the natural language processor 714 and related subcomponents 716-722. After identifying the one or more objects of interest, the request feature identifier 732 may identify one or more common objects of interest (e.g., anomalies, artificial content, natural data, etc.) present in sections of the text (e.g., the one or more text segments of the text). In some embodiments, the common objects of interest in the sections may be the same object of interest that is identified. Once a common object of interest is identified, the request feature identifier 732 may be configured to transmit the text segments that include the common object of interest to an image processing system (shown in FIG. 6) and/or to a comparator.

After identifying common objects of interest using the request feature identifier 732, the query module may group sections of text having common objects of interest. The valuation identifier 734 may then provide a value to each text segment indicating how close the object of interest in each text segment is related to one another (and thus indicates artificial and/or real data). In some embodiments, the particular subject may have one or more of the common objects of interest identified in the one or more sections of text. After identifying a particular object of interest relating to the query (e.g., identifying that one or more of the common objects of interest may be an anomaly), the valuation identifier 734 may be configured to transmit the criterion to an image processing system (shown in FIG. 6) and/or to a comparator (which may then determine the validity of the common and/or particular objects of interest).

It is to be understood that although this disclosure includes a detailed description on cloud computing, implementation of the teachings recited herein are not limited to a cloud computing environment. Rather, embodiments of the present disclosure are capable of being implemented in conjunction with any other type of computing environment currently known or that which may be later developed.

Cloud computing is a model of service delivery for enabling convenient, on-demand network access to a shared pool of configurable computing resources (e.g., networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model with different physical and virtual resources dynamically assigned and reassigned according to demand. There is a sense of portion independence in that the consumer generally has no control or knowledge over the exact portion of the provided resources but may be able to specify portion at a higher level of abstraction (e.g., country, state, or datacenter).

Rapid elasticity: capabilities can be rapidly and elastically provisioned, in some cases automatically, to quickly scale out and rapidly release to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported, providing transparency for both the provider and consumer of the utilized service.

Service models are as follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but the consumer has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software which may include operating systems and applications. The consumer does not manage or control the underlying cloud infrastructure but has control over operating systems, storage, and deployed applications, and the consumer possibly has limited control of select networking components (e.g., host firewalls).

Deployment models are as follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and/or compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure that includes a network of interconnected nodes.

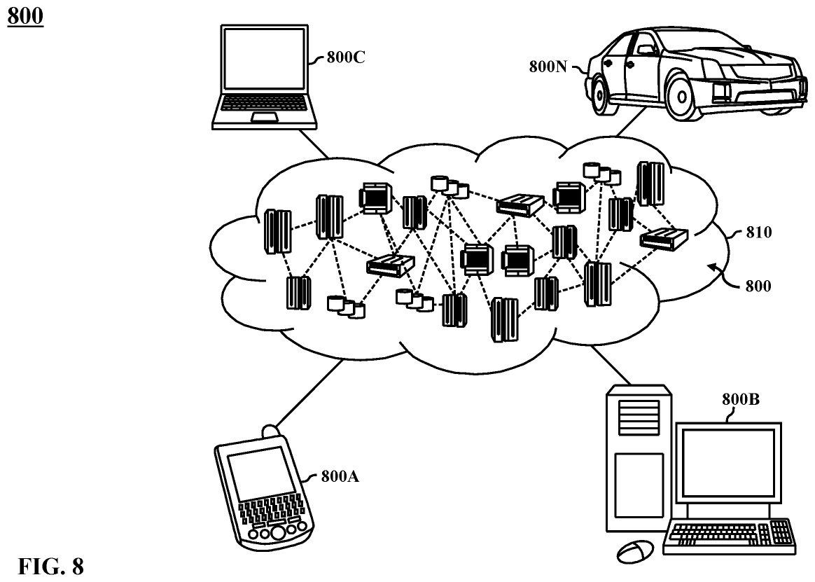

FIG. 8 illustrates a cloud computing environment 810 in accordance with embodiments of the present disclosure. As shown, cloud computing environment 810 includes one or more cloud computing nodes 800 with which local computing devices used by cloud consumers such as, for example, personal digital assistant (PDA) or cellular telephone 800A, desktop computer 800B, laptop computer 800C, and/or automobile computer system 800N may communicate. Nodes 800 may communicate with one another. They may be grouped (not shown) physically or virtually, in one or more networks, such as private, community, public, or hybrid clouds as described hereinabove, or a combination thereof.

This allows cloud computing environment 810 to offer infrastructure, platforms, and/or software as services for which a cloud consumer does not need to maintain resources on a local computing device. It is understood that the types of computing devices 800A-N shown in FIG. 8 are intended to be illustrative only and that computing nodes 800 and cloud computing environment 810 can communicate with any type of computerized device over any type of network and/or network addressable connection (e.g., using a web browser).

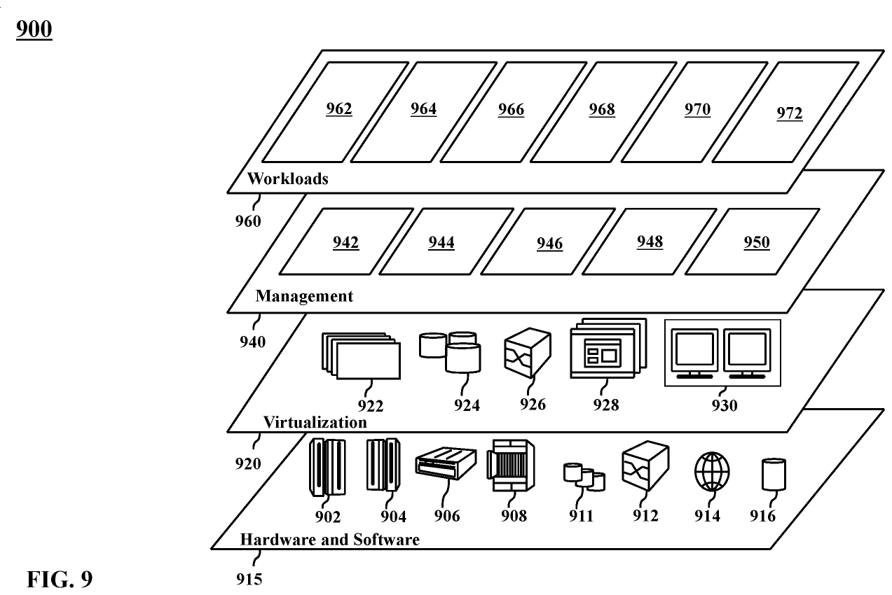

FIG. 9 illustrates abstraction model layers 900 provided by cloud computing environment 810 (FIG. 8) in accordance with embodiments of the present disclosure. It should be understood in advance that the components, layers, and functions shown in FIG. 9 are intended to be illustrative only and embodiments of the disclosure are not limited thereto. As depicted below, the following layers and corresponding functions are provided.

Hardware and software layer 915 includes hardware and software components. Examples of hardware components include: mainframes 902; RISC (Reduced Instruction Set Computer) architecture-based servers 904; servers 906; blade servers 908; storage devices 911;

and networks and networking components 912. In some embodiments, software components include network application server software 914 and database software 916.

Virtualization layer 920 provides an abstraction layer from which the following examples of virtual entities may be provided: virtual servers 922; virtual storage 924; virtual networks 926, including virtual private networks; virtual applications and operating systems 928; and virtual clients 930.

In one example, management layer 940 may provide the functions described below. Resource provisioning 942 provides dynamic procurement of computing resources and other resources that are utilized to perform tasks within the cloud computing environment. Metering and pricing 944 provide cost tracking as resources and are utilized within the cloud computing environment as well as billing or invoicing for consumption of these resources. In one example, these resources may include application software licenses. Security provides identity verification for cloud consumers and tasks as well as protection for data and other resources. User portal 946 provides access to the cloud computing environment for consumers and system administrators. Service level management 948 provides cloud computing resource allocation and management such that required service levels are met. Service level agreement (SLA) planning and fulfillment 950 provide pre-arrangement for, and procurement of, cloud computing resources for which a future requirement is anticipated in accordance with an SLA.

Workloads layer 960 provides examples of functionality for which the cloud computing environment may be utilized. Examples of workloads and functions which may be provided from this layer include: mapping and navigation 962; software development and lifecycle management 964; virtual classroom education delivery 966; data analytics processing 968; transaction processing 970; and predicting a propensity to respond 972.

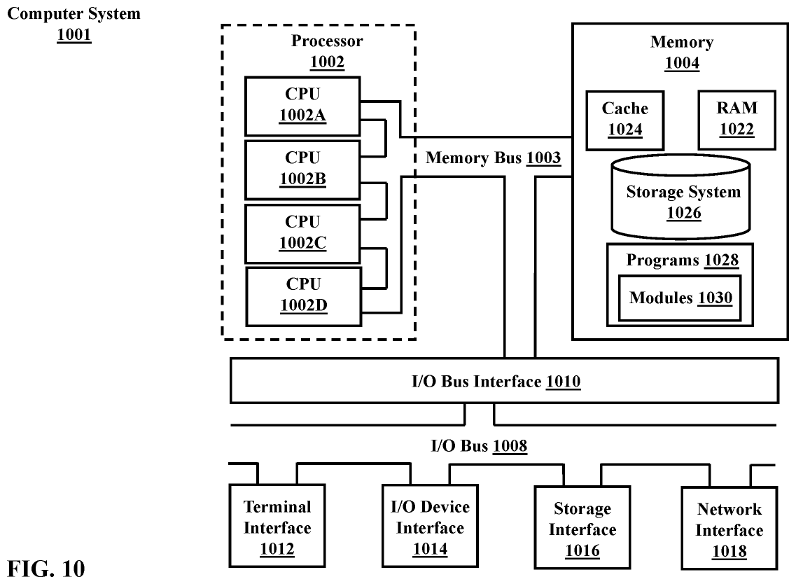

FIG. 10 illustrates a high-level block diagram of an example computer system 1001 that may be used in implementing one or more of the methods, tools, and modules, and any related functions, described herein (e.g., using one or more processor circuits or computer processors of the computer) in accordance with embodiments of the present disclosure. In some embodiments, the major components of the computer system 1001 may comprise a processor 1002 with one or more central processing units (CPUs) 1002A, 1002B, 1002C, and 1002D, a memory subsystem 1004, a terminal interface 1012, a storage interface 1016, an I/O (Input/Output) device interface 1014, and a network interface 1018, all of which may be communicatively coupled, directly or indirectly, for inter-component communication via a memory bus 1003, an I/O bus 1008, and an I/O bus interface unit 1010.

The computer system 1001 may contain one or more general-purpose programmable CPUs 1002A, 1002B, 1002C, and 1002D, herein generically referred to as the CPU 1002. In some embodiments, the computer system 1001 may contain multiple processors typical of a relatively large system; however, in other embodiments, the computer system 1001 may alternatively be a single CPU system. Each CPU 1002 may execute instructions stored in the memory subsystem 1004 and may include one or more levels of on-board cache.

System memory 1004 may include computer system readable media in the form of volatile memory, such as random access memory (RAM) 1022 or cache memory 1024. Computer system 1001 may further include other removable/non-removable, volatile/non-volatile computer system storage media. By way of example only, storage system 1026 can be provided for reading from and writing to a non-removable, non-volatile magnetic media, such as a “hard drive.” Although not shown, a magnetic disk drive for reading from and writing to a removable, non-volatile magnetic disk (e.g., a “floppy disk”), or an optical disk drive for reading from or writing to a removable, non-volatile optical disc such as a CD-ROM, DVD-ROM, or other optical media can be provided. In addition, memory 1004 can include flash memory, e.g., a flash memory stick drive or a flash drive. Memory devices can be connected to memory bus 1003 by one or more data media interfaces. The memory 1004 may include at least one program product having a set (e.g., at least one) of program modules that are configured to carry out the functions of various embodiments.

One or more programs/utilities 1028, each having at least one set of program modules 1030, may be stored in memory 1004. The programs/utilities 1028 may include a hypervisor (also referred to as a virtual machine monitor), one or more operating systems, one or more application programs, other program modules, and program data. Each of the operating systems, one or more application programs, other program modules, and program data, or some combination thereof, may include an implementation of a networking environment. Programs 1028 and/or program modules 1030 generally perform the functions or methodologies of various embodiments.

Although the memory bus 1003 is shown in FIG. 10 as a single bus structure providing a direct communication path among the CPUs 1002, the memory subsystem 1004, and the I/O bus interface 1010, the memory bus 1003 may, in some embodiments, include multiple different buses or communication paths, which may be arranged in any of various forms, such as point-to-point links in hierarchical, star, or web configurations, multiple hierarchical buses, parallel and redundant paths, or any other appropriate type of configuration. Furthermore, while the I/O bus interface 1010 and the I/O bus 1008 are shown as single respective units, the computer system 1001 may, in some embodiments, contain multiple I/O bus interface units 1010, multiple I/O buses 1008, or both. Further, while multiple I/O interface units 1010 are shown, which separate the I/O bus 1008 from various communications paths running to the various I/O devices, in other embodiments some or all of the I/O devices may be connected directly to one or more system I/O buses 1008.

In some embodiments, the computer system 1001 may be a multi-user mainframe computer system, a single-user system, a server computer, or similar device that has little or no direct user interface but receives requests from other computer systems (clients). Further, in some embodiments, the computer system 1001 may be implemented as a desktop computer, portable computer, laptop or notebook computer, tablet computer, pocket computer, telephone, smartphone, network switches or routers, or any other appropriate type of electronic device.

It is noted that FIG. 10 is intended to depict the representative major components of an exemplary computer system 1001. In some embodiments, however, individual components may have greater or lesser complexity than as represented in FIG. 10, components other than or in addition to those shown in FIG. 10 may be present, and the number, type, and configuration of such components may vary.

The present disclosure may be a system, a method, and/or a computer program product at any possible technical detail level of integration. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide, or other transmission media (e.g., light pulses passing through a fiber-optic cable) or electrical signals transmitted through a wire.

Computer readable program instructions described herein can be downloaded to respective computing/processing devices from a computer readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, configuration data for integrated circuitry, or source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer, or entirely on a remote computer or server. In the latter scenario, the remote computer may be connected to the user's computer through any type of network, including a local area network (LAN) or a wide area network (WAN) or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus, or other device to produce a computer implemented process such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Although the present disclosure has been described in terms of specific embodiments, it is anticipated that alterations and modifications thereof will become apparent to the skilled in the art. The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application, or the technical improvement over technologies found in the marketplace or to enable others of ordinary skill in the art to understand the embodiments disclosed herein. Therefore, it is intended that the following claims be interpreted as covering all such alterations and modifications as fall within the true spirit and scope of the disclosure.

What is claimed is:

1. A system, said system comprising:
a memory; and
a processor in communication with said memory, said processor being configured to perform operations, said operations comprising:
analyzing a database;
identifying an announcement in said database;
compiling a user pool for said announcement, wherein said user pool includes one or more users;
generating a predicted likelihood of response for each of said one or more users; and
providing an indication to an operator of said predicted likelihood of response.

2. The system of claim 1, said operations further comprising:
ranking said one or more users according to said predicted likelihood of response.

3. The system of claim 1, said operations further comprising:
identifying a user profile based on one or more user skills; and
calculating said predicted likelihood of response based on said user profile.

4. The system of claim 1, said operations further comprising:
extracting data from a social profile, a talent market repository, a company repository, and a news repository; and
submitting said data to said database.

5. The system of claim 1, said operations further comprising:
obtaining announcement information from said database;
extracting data from at least one external source; and
calculating a calculation with said announcement information and with said data, wherein said calculation is used to generate said predicted likelihood of response.

6. The system of claim 1, said operations further comprising:
selecting one or more qualified users from said user pool based on sought qualifications of said announcement and a qualifications profile for each of said one or more users.

7. The system of claim 1, said operations further comprising:
ascertaining a salient feature indicative of said predicted likelihood of response.

8. A method, said method comprising:
analyzing a database;
identifying an announcement in said database;
compiling a user pool for said announcement, wherein said user pool includes one or more users;
generating a predicted likelihood of response for each of said one or more users; and
providing an indication to an operator of said predicted likelihood of response.

9. The method of claim 8, further comprising:
ranking said one or more users according to said predicted likelihood of response.

10. The method of claim 8, further comprising:
identifying a user profile based on one or more user skills; and
calculating said predicted likelihood of response based on said user profile.

11. The method of claim 8, further comprising:
extracting data from a social profile, a talent market repository, a company repository, and a news repository; and
submitting said data to said database.

12. The method of claim 8, further comprising:
training a machine learning model to calculate said predicted likelihood of response.

13. The method of claim 8, further comprising:
obtaining announcement information from said database;
extracting data from at least one external source; and
calculating a calculation with said announcement information and with said data, wherein said calculation is used to generate said predicted likelihood of response.

14. The method of claim 8, further comprising:
selecting one or more qualified users from said user pool based on sought qualifications of said announcement and a qualifications profile for each of said one or more users.

15. The method of claim 8, further comprising:
ascertaining a salient feature indicative of said predicted likelihood of response.

16. A computer program product, said computer program product comprising a computer readable storage medium having program instructions embodied therewith, said program instructions executable by a processor to cause said processor to perform a function, said function comprising:
analyzing a database;
identifying an announcement in said database;
compiling a user pool for said announcement, wherein said user pool includes one or more users;
generating a predicted likelihood of response for each of said one or more users; and
providing an indication to an operator of said predicted likelihood of response.

17. The computer program product of claim 16, said function further comprising:
ranking said one or more users according to said predicted likelihood of response.

18. The computer program product of claim 16, said function further comprising:
identifying a user profile based on one or more user skills; and
calculating said predicted likelihood of response based on said user profile.

19. The computer program product of claim 16, said function further comprising:
obtaining announcement information from said database;
extracting data from at least one external source; and
calculating a calculation with said announcement information and with said data, wherein said calculation is used to generate said predicted likelihood of response.

20. The computer program product of claim 16, said function further comprising:
selecting one or more qualified users from said user pool based on sought qualifications of said announcement and a qualifications profile for each of said one or more users.
